(19) United States
(12) Patent Application Publication
(10) Pub. No.: US 2023/0344029 A1
(43) Pub. Date: Oct. 26, 2023

(54) METHODS AND DEVICES FOR DETERMINING AC FREQUENCY FOR PEAK HEATING A BATTERY HAVING AN ELECTROLYTE

(71) Applicant: Omnitek Partners LLC, Ronkonkoma, NY (US)

(72) Inventor: Jahangir S Rastegar, Stony Brook, NY (US)

(73) Assignee: Omnitek Partners LLC, Ronkonkoma, NY (US)

(21) Appl. No.: 18/125,099

(22) Filed: Mar. 22, 2023

Related U.S. Application Data
(60) Provisional application No. 63/429,994, filed on Dec. 3, 2022.
(60) Provisional application No. 63/322,524, filed on Mar. 22, 2022.

(51) Int. Cl. H01M 10/48; H01M 10/65; H01M 10/615; H01M 10/44

(52) U.S. Cl. CPC H01M 10/486; H01M 10/44; H01M 10/615; H01M 10/65

(57) ABSTRACT

System for direct battery electrolyte and supercapacitor heating and temperature maintenance at low temperatures when coupled to a battery and/or supercapacitor having a core with an electrolyte having ions therein and having inputs, with one of the inputs having characteristics of a frequency-dependent resistor and inductor series coupled to a voltage source, the device including: at least one power storage and source couplable to the one input; and a controller configured to control the power storage and source to provide alternating between a positive input current and a negative input current at the one input, wherein the controller is configured to control the power storage and source to provide the alternating positive and negative input currents at a high-frequency configured to substantially maximize an internal heating effect of the ions within the electrolyte to generate heat and raise a temperature of the electrolyte.

### CROSS REFERENCE TO RELATED APPLICATIONS

This application claims the benefit of U.S. Provisional application Nos. 63/322,524, filed on Mar. 22, 2022 and 63/429,994, filed on Dec. 3, 2022, the entire contents of each of which are incorporated here by reference.

### FIELD OF THE PRESENT SYSTEM

The present system relates to a novel technology and a method of operation thereof for direct and rapid heating of battery electrolyte at low temperatures and maintaining the battery temperature at its optimal performance level. The present novel technology is applicable to almost all primary and secondary batteries, such as Lithium-ion, Lithium-polymer, NiMH and lead-acid batteries. The present novel technology is also applicable to super-capacitors to rapidly heat super-capacitors at temperatures as low as -54 deg. C without any damage. The present novel technology provides for direct battery electrolyte and supercapacitor heating and temperature maintenance when the batteries are at low temperatures and method of operation thereof. The present system has been extensively tested on a wide range of primary and secondary batteries at temperatures as low as -54 deg. C without causing any damage to the batteries.

### BACKGROUND OF THE PRESENT SYSTEM

The performance of batteries and super-capacitors is significantly reduced at low temperatures. This is the case for both primary and rechargeable batteries. In addition, current lithium-ion and Lithium-polymer battery technology does not allow battery charging at temperatures below zero degrees C and charging at temperatures below their optimal level has been shown to reduce battery life.

Current solutions that try to address cold weather effects on batteries include heating the exterior of the battery by integrating “heaters” into the battery compartment or using heating blankets, or recently by embedding heating elements inside the batteries.

Accordingly, embodiments of the present system provide features and advantages which obviate conventional battery heating systems and methods. To overcome the aforementioned barriers and detriments as well as others, there is a need for a system and method which can reliably heat primary and secondary batteries of varied types at low temperatures thus overcoming the aforementioned barriers and detriments as well as others of conventional systems.

### SUMMARY OF THE PRESENT SYSTEM

The system(s), device(s), method(s), arrangements(s), interface(s), computer program(s), processes, circuits, model, etc., (hereinafter each of which will be referred to as system, unless the context indicates otherwise), described herein address problems in prior art systems.

In accordance with embodiments of the present system, there is disclosed a system, (e.g., methods, devices, etc.) for direct and rapid heating of battery electrolyte at low temperatures and maintaining the battery temperature at its optimal performance level. The present system is applicable to a wide range of primary and secondary batteries at temperatures as low as -54° C. and may be utilized to heat one or more batteries without causing any damage to the one or more batteries. The technology is applicable to almost all primary and secondary batteries and combinations thereof, such as Lithium-ion, Lithium-polymer, NiMH and/or lead-acid batteries. The technology is also applicable to super-capacitors and has been used to rapidly heat super-capacitors at temperatures as low as -54° C. without any damage.

The present system(s) is/are based on direct heating of the battery electrolyte using appropriately formed high frequency AC currents in accordance with embodiments of the present system. The present system(s) take advantage of the electrical characteristics of the batteries and super-capacitors when energized in accordance with the present system to heat the electrolyte directly and very rapidly to its optimal operating temperature without causing any damage.

### BRIEF DESCRIPTION OF THE DRAWINGS

It should be expressly understood that the drawings are included for illustrative purposes and do not represent the scope of the present system. It is to be understood that the figures may not be drawn to scale. Further, the relation between objects in a figure may not be to scale and may in fact have a reverse relationship as to size. The figures are intended to bring understanding and clarity to the structure of each object shown, and thus, some features may be exaggerated in order to illustrate a specific feature of a structure. In the accompanying drawings, like reference numbers in different drawings may designate identical or similar elements, portions of similar elements and/or elements with similar functionality.

The present system is explained in further detail, and by way of example, with reference to the accompanying drawings which show features of various exemplary embodiments that may be combinable and/or severable wherein:

FIG. 1 illustrates a plot of relative capacity of Li-ion batteries as a function of temperature in accordance with embodiments of the present system;

FIG. 2 illustrates a plot of State of Health (SOH) of 18650 Li-ion batteries vs. number of cycles as a function of operating temperature in accordance with embodiments of the present system;

FIG. 3 illustrates a liquid-solid phase diagram of Ethyl methyl carbonate- Ethyl carbonate (EMC-EC) where the closed dots represent measured data for three different solutions of LiPF6 in an EMC-EC solvent in accordance with embodiments of the present system;

FIG. 4 illustrates an equivalent (lumped) circuit model of a battery that is subjected to a high-frequency AC current in accordance with embodiments of the present system;

FIG. 5 illustrates an equivalent circuit model of a battery for high frequency heating at a given battery temperature in accordance with embodiments of the present system;

FIG. 6 illustrates a plot of the amplitude of an applied test AC voltage at the battery terminals of a battery as a function of frequency in accordance with embodiments of the present system;

FIG. 7 illustrates a plot of an amplitude of the applied test AC current at the battery terminals as a function of frequency in accordance with embodiments of the present system;

FIG. 8 illustrates a plot of the amplitude ratio of voltage and current as a function of frequency in accordance with embodiments of the present system;

FIG. 9 illustrates a plot of phase angle (leading) between the voltage and current waveforms of FIGS. 6 and 7, respectively in accordance with embodiments of the present system;

FIG. 10 illustrates a plot of heating rate at room temperature for a tested CR123A Li-ion battery as a function of heating current frequency with a fixed RMS current of 4 A in accordance with embodiments of the present system;

FIG. 11 illustrates a plot of heating curves for a CR123 Li-ion battery by externally supplied power at 80 KHz at various AC current amplitudes in accordance with embodiments of the present system;

FIG. 12 illustrates a plot of heating rate of the CR123 Li-ion battery with 80 kHz current of different amplitudes as measured and as predicted by a developed model in accordance with embodiments of the present system;

FIG. 13 illustrates a schematic of an exemplary high-frequency current battery heating circuit that is powered by an external power source in accordance with embodiments of the present system;

FIG. 14 illustrates a schematic of a high-frequency current battery heating circuit that is powered by the battery power for self-heating in accordance with embodiments of the present system;

FIG. 15 illustrates a plot of high-frequency heating rate curves for a Li-ion CR123 battery from several low temperatures to room temperature using externally provided power source to power the heating circuit in accordance with embodiments of the present system;

FIG. 16 illustrates a plot of the temperature of a Li-ion CR123 battery being self-heated in an extreme cold environment of -60° C. and a plot of a companion Li-ion CR123 battery that is not heated illustrating operation of the present system in accordance with embodiments of the present system;

FIG. 17 illustrates a plot of the temperature of a large Lead-acid battery as its temperature is maintained within a specified range with the high-frequency AC current battery electrolyte heating system of FIG. 13 in accordance with embodiments of the present system;

FIG. 18 illustrates a heating rate for a 12 V Type 29HM lead acid battery at room temperature with externally powered high-frequency AC current as a function of current frequency and applied current in accordance with embodiments of the present system;

FIG. 19 illustrates a graph showing battery voltage as a function of frequency with battery current held constant at 20 A in accordance with embodiments of the present system;

FIG. 20 illustrates a graph showing battery current as a function of frequency with battery voltage held constant at 50 mV in accordance with embodiments of the present system;

FIG. 21 illustrates a graph showing battery frequency response in accordance with embodiments of the present system;

FIG. 22 illustrates a graph showing measured heating rates for the Die Hard 12 V lead acid battery at constant currents in accordance with embodiments of the present system;

FIG. 23 illustrates a Li-ion battery electrolyte AC voltage heating test set-up in accordance with embodiments of the present system; and

FIG. 24 illustrates a graph showing plots of electrolyte heating of an 18650 Li-ion battery cell as measured by the battery surface temperature as a function of time in accordance with embodiments of the present system.

### DETAILED DESCRIPTION OF THE PRESENT SYSTEM

The term “and/or,” and formatives thereof, should be understood to mean that only one or more of the recited elements may need to be suitably present (e.g., only one recited element is present, two of the recited elements may be present, etc., up to all of the recited elements may be present) in a system in accordance with the claims recitation and in accordance with one or more embodiments of the present system. In the context of the present embodiments, the terms “about”, substantially and “approximately” denote an interval of accuracy that a person skilled in the art will understand to still ensure the technical effect of the feature in question which in some cases may also denote “within engineering tolerances.” For example, the terms may indicate a “deviation” from indicated numerical value(s) of ±20 %, ±15 %, ±10 %, ±5 %, ±1 % ±0.5 % or ±0.1 %.

This disclosure is directed to novel systems (e.g., methods, devices, etc.) for the direct and rapid heating of battery electrolyte at low temperatures and maintaining the battery temperature at its optimal performance level. The present novel system has been extensively tested on a wide range of primary and secondary batteries at temperatures as low as -54° C. without causing any apparent damage to the batteries. The technology is applicable to almost all primary and secondary batteries, such as Lithium-ion, Lithium-polymer, NiMH and lead-acid batteries. The technology is also applicable to super-capacitors and has been tested to rapidly heat super-capacitors that start at temperatures as low as -54° C. without any damage.

The present novel system is based on direct heating of the battery electrolyte using appropriately formed high frequency AC currents. The present system takes advantage of the electrical characteristics of the batteries and super-capacitors to heat the electrolyte directly and very rapidly to its optimal operating temperature without causing any damage.

The developed electrolyte heating system may be externally powered at extremely low temperatures at which the battery is unable to provide a significant amount of power. Once the battery can provide enough power, the battery temperature may be raised to its optimal level and maintained at that level by power from the battery itself utilizing systems in accordance with embodiments of the present system. The battery may be fully charged or discharged in accordance with embodiments of the present system.

The developed electrolyte heating systems are inherently highly efficient and safe and can be readily integrated into the battery safety and protection circuitry and battery chargers without requiring modification to the battery itself or additions to the battery as in prior systems.

The following are some of the main characteristics of the developed systems:
It requires no modification to the battery and super-capacitor;
The basic physics of the system and extensive tests clearly show no damage to the battery and super-capacitor when the present system is utilized;
The battery pack protection electronic units, such as those for Lithium-ion and Lithium-polymer batteries, can be modified to ensure continuous high-performance operation at low temperatures in accordance with embodiments of the present system;
The battery electrolyte and super-capacitor is directly and uniformly heated when utilizing the present system, therefore bringing a very cold battery to its optimal operating temperature very rapidly while minimizing heat loss from the battery is achieved, and that heretofore was not by conventional systems;
Direct electrolyte heating utilizing the present system requires significantly less electrical energy than external heating such as with the use of heating blankets;
Standard sized Li-ion or Li-polymer batteries can be used instead of thin and flat battery stack packaging utilized by conventional systems to accelerate external heating via heating blankets or the like;
The present system is simple to implement and provides a benefit of low-cost that conventional system do not provide.

Illustratively, the developed system and basic design and operation of an electrolyte heating unit in accordance with embodiments of the present system are described herein and sample heating curves from -54° C. to 20° C. for Li-ion, Li-polymer and lead-acid batteries are illustratively presented and discussed.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, tools, techniques and methods are omitted so as not to obscure the description of the present system.

The present highly innovative high-frequency AC current direct electrolyte heating system is based on in-depth studies, that were carried out by the inventor, of the highly nonlinear dynamic behavior of the battery electrolyte components when subjected to a high-frequency electric field, which results in generation of heat in the battery electrolyte. Based on the results of these studies, a model in accordance with the present novel system is presented that describes battery electrolyte heating rate, i.e., the high-frequency direct heating of a battery electrolyte, as a function of the electrolyte temperature, AC current (RMS) magnitude, and frequency. The model is also applicable to high-frequency AC current heating of supercapacitors. It is noted that the applied AC current of the present system may be or is generally desired to be symmetric, i.e., have no or negligible DC component.

In the present direct electrolyte heating system, the applied high-frequency AC currents are in the range of 50-120 KHz for Lithium-ion and Lithium-Polymer and 10-50 KHz for Lead-Acid batteries, similarly high for other rechargeable and primary batteries, including thermal reserve and liquid reserve batteries, and 1-2 MHz for super-capacitors.

It is appreciated by those skilled in the art that the use of AC heating signals of up to around 1 KHz has been referred to as “high-frequency” in some battery heating discussions found in the published literature. In the present direct electrolyte heating technology, the term “high-frequency” refers to frequencies that are well above (i.e., substantially) frequencies (around 1 KHz) that have been used and analyzed using linear electrical models to determine the maximum resistive battery heating rates. Historically, there has been considerable interest in the electrical properties of batteries around 1 kHz. Around this range of frequencies, the battery appears inductive above and capacitive below some resonance frequency. These frequency dependent effects are characterized by the modified Randles equivalent battery circuit model (see for example: Randles, J. E. B. (1947). “Kinetics of rapid electrode reactions”. Discussions of the Faraday Society. 1: 11. doi:10.1039/df9470100011. ISSN 0366-9033, and A. Lasia, A., Electrochemical impedance spectroscopy and its applications. In: Modern Aspects of Electrochemistry. Volume 32. Kluwer Academic/Plenum Pub. 1999, Ch.2, p. 143), which is valid for frequencies of up to around 1 kHz. The model is not valid at higher frequencies used in the present technology since it does not include the components related to the highly nonlinear dynamic behavior of the battery electrolyte, which is related to the highly nonlinear dynamic behavior of ionic oscillatory motions in the battery electrolyte. As it is described herein this disclosure, the high-frequency ionic oscillatory motion inside the battery electrolyte results in a high rate of the battery electrolyte heating, which at a given temperature and AC current level, increases with frequency to a peak level and begins to drop with increased frequency. At these high AC current frequencies, the heating rate is shown to be nearly proportional to the square of the applied RMS current.

As an example, in the disclosed direct electrolyte heating system, at room temperature, the applied high-frequency AC currents may be in the range of 50-120 KHz for Lithium-ion and Lithium-Polymer and 10-50 KHz for Lead-Acid batteries, and 1-2 MHz for super-capacitors.

It is also appreciated by those skilled in the art that the aforementioned commonly used linear electric circuit battery models would indicate negligible and close to zero net battery heating power at frequencies above around 1 KHz due to close to the resulting around 90 degrees phase shift between the applied current and voltage that such models would indicate. It is also appreciated by those skilled in the art that some heating is inevitable due to low frequency (up to around the resonant frequency of around 1-2 KHz for most rechargeable batterie) and DC current flow through the internal resistance indicated by the aforementioned linear battery circuit models during charging and discharging as with the application of the so-called “mutual pulse heating”. The resultant heating processes due to such current flows are unavoidable, but their magnitudes are minimal using the present system as compared to the prior systems high-frequency AC current heating, since batteries are designed to exhibit minimal internal resistance, particularly for use in cold environments.

The high-frequency electrolyte heating system heats the battery electrolyte directly and uniformly with the least amount of electrical energy as compared to other currently available technologies, i.e., by external heating pads or blankets or the so-called “mutual pulse heating”, and by the provision of internal heating elements. The prior heating pads and blankets consume the most amount of energy since they must heat the entire battery mass, while overcoming heat loss from their outer surfaces. The heating pads and blankets are also thermodynamically inefficient as well as consuming the most amount of energy since they must heat the entire battery mass, while overcoming heat loss from their outer surfaces. The prior heating process is also slow as compared to the present system since heat must be conducted into the battery core. The internally provided electrical heating members consume less energy than heating pads and blanket, but are relatively slow, since they also rely on heat conduction, and at very low temperatures, they require higher current rates, which could damage the battery due to hot spots. Batteries with internal heating members are more costly to produce and do not currently have enough market for large volume production.

The disclosed high-frequency AC current direct battery electrolyte heating system may use either an external source of power or the battery’s internal power to rapidly bring the electrolyte temperature to its optimal temperature and to maintain that temperature for the best possible battery charging and discharging performance and its cycle life. For instance, by operating Li-ion batteries within their optimal temperature range of 20-30° C. in accordance with the present system, the battery cycling life is significantly improved, and maximum amount of stored energy and current becomes available for powering electrical equipment.

The present system has been extensively tested on Li-ion, Li-polymer, Lead-Acid, NiMH, and many other battery chemistries, and super-capacitors without causing any damage. The present system is implemented without making any modifications to the battery and can bring batteries to their optimal operating and charging temperatures at environmental temperatures that could be as low as -60° C. without any damage.

The present system utilizing high-frequency AC current direct electrolyte heating technology that is inherently highly efficient and safe and can be readily integrated into any battery safety and protection circuitry and readily integrated into battery chargers. The following are some characteristics of the present system:
It requires no modification to the battery.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating system/circuit may either be powered by external sources or use the battery power for self-heating to maintain its core temperature at the optimal level.
The battery pack protection electronic systems, such as those for Lithium-ion and Lithium-polymer batteries, can be readily modified to ensure continuous high-performance charging and operation at low temperatures.
The battery electrolyte is directly and uniformly heated, therefore bringing a very cold battery to its optimal operating temperature very rapidly and minimizing heat loss from the battery.
Direct electrolyte heating utilizing the present system requires significantly less electrical energy than external heating with heating pads or blankets or by internally provided electrical heating members.
Standard sized Li-ion or Li-polymer batteries can be used in accordance with the present system instead of thin and flat battery stack packaging to accelerate external heating via heating blankets or the like.
The present system is simple, uses commonly used electronic components, can be packaged in small volumes, and is low-cost.

The performance of all batteries is degraded significantly at low temperatures. This is the case for both primary and rechargeable batteries. In addition, current Lithium-ion and Lithium-polymer battery technology does not allow battery charging at temperatures below 0° C. and charging at temperatures below their optimal level has been shown to reduce battery life cycle. In very cold environments in which the temperature could fall to -10° C., -20° C., and at times as low as -40° C. or even lower, batteries can only provide a very small percentage of their stored energy and current, sometimes less than 5-10 percent and in some cases effectively none. For rechargeable batteries, particularly for high energy density batteries of interest in most applications, such as Li-ion and Li-polymer batteries, battery charging as well as operation at low and particularly at very low temperatures raises issues that if unsolved would prevent their use for powering many systems of interest.

Some of the main issues limiting the use of any chemical battery, particularly high-density rechargeable batteries, such as Li-ion or Li-polymer batteries, are briefly reviewed below, followed by a description of prior technologies to address these issues and their shortcomings, followed by the description of how the disclosed high-frequency AC current direct battery electrolyte heating system in accordance with embodiments of the present system would address all the indicated issues for operating various battery-operated devices in cold and even extreme cold environments.

### Decreased Discharge Capacity of Li-ion Batteries at Low Temperature

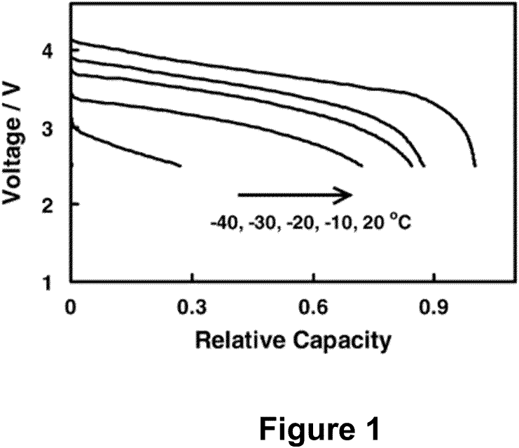

The discharge performance of Lithium-ion batteries is significantly decreased as the temperature falls below -10° C. As shown in FIG. 1. For example, at -40° C., commercial 18650 Li-ion batteries can only deliver 5% of the energy density, and 1.25% of the power density than at 20° C. (G. Nagasubramanian, “Electrical characteristics of 18650 Li-ion cells at low temperatures,” Journal of Applied Electrochemistry, vol. 31, pp. 99-104, 2001). This also applies to Lithium-polymer and other similarly designed batteries. The decrease in the ionic conductivity of the electrolyte and the solid electrolyte interface (SEI) layer; and the limited diffusivity of Lithium ions within the graphite anode electrodes are not the only contributors to the poor low temperature performance. In fact, when the temperature falls below -10° C., the dominant component is the slow kinetics of the battery reactions (S. S. Zhang, K. Xu and T. R. Jow, “The low temperature performance of Li-ion batteries,” Journal of Power Sources, vol. 115, pp. 137-140, 2003). Therefore, solutions that call for the use of more ionically conductive electrolytes, or additives to improve the anode electrode conductivity to improve low temperature performance are not good enough solutions at very low temperatures. The thermodynamics of the Lithium ions intercalation/de-intercalation process and the kinetics of the redox reactions ultimately determine the maximum possible discharge capacity of a lithium-ion battery at low temperatures.

### Low Temperature Charging

Charging a standard Li-ion and Li-polymer and other similar batteries below 0° C. must always be avoided. During the charging process, the low temperature causes the negative electrode’s lattice to contract, leaving insufficient space for lithium ions to intercalate. In addition, the charge transfer and solid-phase diffusion processes slow down significantly at low temperature. This results in the formation of lithium metal deposits (e.g., Lithium plating) on the surface of the negative electrode. The formation of lithium metal deposits causes irreversible loss of battery capacity since this fixed lithium is not available any longer during the discharge step. The larger the charging current, the more severe the damage to the electrode structure, and the faster the battery loses irreversible capacity. Further, the non-homogeneous growth of lithium metal deposits can easily form lithium dendrites that can grow large enough to puncture through the polymeric separator and short the battery, causing internal hot spots and potential for a fire or explosion of the battery.

### Accelerated Aging when Li-Ion Batteries are Cycled in Low Temperature Conditions

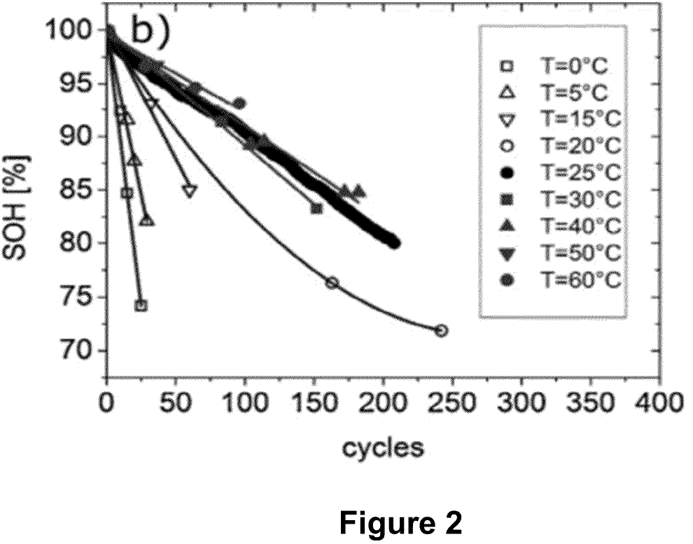

It has been widely reported (for example, Waldman, T, M. Kasper, M. Wilka, M. Fleischammer and M. Wohlfahrt, “Temperature dependent aging mechanisms in Lithium-ion batteries-A Post-Mortem study,” Journal of Power Sources, vol. 262, pp. 129-135, 2014), that commercial 18650-type Li-ion batteries age significantly faster when they are operated in low temperature conditions. FIG. 2 illustrates the effect of temperature on the number of charge/discharge cycles before the state of health (SOH) of the battery drops below 80%. The aging rate increases exponentially (Arrhenius dependency) with drop in temperature. For example, if a battery is continuously operated at 5° C., the number of cycles before it reaches an 80% SOH is only 10% than if the battery is operated at 25° C.

### Electrolyte Freezing at Ultra Low Temperature

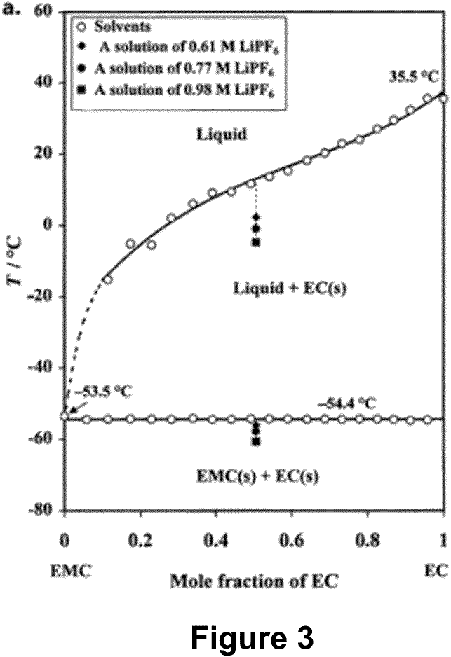

The standard Li-ion battery electrolyte consists of mixtures of two liquid organic carbonates (e.g., 50% mol fraction of ethylene carbonate EC, 50% mol fraction of ethyl methyl carbonate, EMC), and a Lithium salt (e.g., Lithium hexafluoro phosphate, LiPF6). On their own, EC and EMC freeze at 35.5° C., and at -53.5° C., respectively. FIG. 3 shows the liquidus point of mixtures of EC+EMC (M. S. Ding, X. Kang and R. Jow, “Liquid-Solid Phase Diagrams of Binary Carbonates for Lithium Batteries,” Journal of the Electrochemical Society, vol. 147, no. 5, pp. 1688-1694, 2000). The liquidus point of a 50% vol. EC/EMC mixture is around 10° C. The addition of 1 M LiPF6 Lithium salt depresses the liquidus point down to -10° C. In fact, this is the recommended low temperature usable range of lithium-ion batteries, because if the temperature is dropped below the liquidus point, the first solids of electrolyte start to appear. As the temperature is further decreased, more and more solids form until the entire electrolyte volume freezes solid below -60° C. If the temperature is increased, battery capacity is recovered as the electrolyte remelts. However, small amounts of the Lithium salt LiPF6 might remain undissolved in the liquid electrolyte. Thus, with every freezing-thawing cycle, the battery loses some capacity as more and more LiFP6 salt remains undissolved. Therefore, if a battery is regularly exposed to artic temperatures, even without being used, it will eventually lose all capacity.

The present system which addresses the above issues and their shortcomings and/or others is described further herein.

The prior technology for heating batteries in cold temperature environments so that they can be charged without battery damage and be conditioned to effectively provide their stored energy and current to power various battery-operated devices in cold environments are: (1) “self-internal heating”, in which the hattery is heated through internal resistance of the battery. The so-called “mutual pulse heating” is also in this category since it also heats the battery through its internal resistance, even though the heating current is supplied by the paired batteries; (2) heating batteries by externally generated heat, such as by heating pads or heating blankets, or convective heating by blowing heated air through the battery pack or the like; (3) heating batteries via internally provided electrical heating members, which are powered by either external sources or by the battery power.

The above basic categories of battery heating methods have shortcomings that make them impractical and/or undesirable for a wide range of systems and devices for operation in cold environments, in particular operation in extreme cold environments. These shortcomings may be described briefly as follows:
1) Self-Internal Heating: In these methods, the battery is heated through internal resistance of the battery. In operation in cold and particularly in extreme cold environments, even when the load is using the maximum available current, the amount of generated heat is not enough to keep the battery warm, and its temperature would rapidly drop as the battery temperature drops followed by available current drop in a viscous cycle that would quickly lead to the lack of enough current to power the intended device. The only general option for heating through internal resistance would then be the use of the so-called “mutual pulse heating”, which for the very cold and extreme cold environment operation would require the application of very high (effectively DC) currents (using DC-DC converters) through the battery, which would damage the battery.
2) Heating by Externally Generated Heat: In this method, heat is generated by externally positioned heating elements such as resistive heating coils, and used to heat the battery through conduction, for example by heating pads or blankets, or through convection, by blowing a hot medium such as air over the batteries. The power to generate heat may be from external sources or from the battery itself. Heat conduction inside the battery pack becomes the limiting factor due to the thickness of the battery cell and the insulating nature of the outer battery layers. This leads to a large temperature gradient inside the battery. As a result, these heating methods are not energy efficient and have slow heating rate. In addition, the heating pads and blankets and other heating components significantly increase the total occupied power source volume, and thereby also the amount of energy needed to keep the battery warm and compensate for the increased heat loss through the increased outside surfaces of the power source. In short, these methods are impractical and undesirable for a wide range of system and device powering for cold environments and particularly for extreme cold environments.
3) Heating by Internally Provided Electrical Heating Members: This method heats up the battery, by Joule heating, through the addition of internally provided electrical resistance heating elements within the battery. The heating power may be supplied by external sources or some of the internal battery power may be diverted through the resistance elements. However, for rapid heating rates that are required for operation in very cold environments, high current heating rates are required, which would create high overpotential. Therefore, heating during the charging step should be avoided to prevent plating of Li metal. Large temperature gradients and hot spots are possible, which can cause high temperature electrolyte degradation, off-gassing, and ultimately fire and explosion hazards.

### High-Frequency Battery Heating for Cold and Extreme Cold Environments in Accordance with Embodiments of the Present System

The present system provides for high-frequency battery heating for cold and extreme cold environments. A battery model is presented in accordance with the present system that represents the dynamic behavior of its electrolyte when subjected to high-frequency AC current and the basic physics of this behavior is described. Actual tests performed to validate the developed present model and the method used to determine the parameters of the model for a selected small Lithium-ion battery are presented in accordance with illustrative embodiments of the present system. The present model and the disclosed method to determine its parameters in accordance with embodiments of the present system is general and valid for all primary, rechargeable, as well as reserve batteries such as liquid reserve and thermal reserve batteries widely used in munitions. Actual test results of the selected Lithium-ion battery heating at temperatures as low as -58° C. is also presented utilizing illustrative embodiments of the present system. The results of self-heating tests utilizing illustrative embodiments of the present system for keeping battery core temperature at room temperature in a -60° C. environment is also provided.

### A) Basic Circuit Model of Batteries Subjected to High-Frequency AC Current in Accordance with Embodiments of the Present System

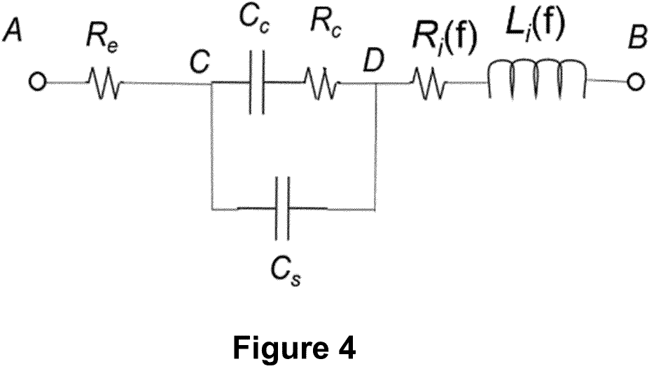

The basic operation of any (most) battery may be approximately modeled in accordance with embodiments of the present system with the equivalent (lumped) circuit shown in FIG. 4. In the following discussion on battery heating in accordance with embodiments of the present system, electrical circuit elements and terminology is utilized for convenience to demonstrate their approximated physical behavior in a battery. The temperature and frequency dependance of the elements used to model the battery electrolyte component of the battery is described in accordance with embodiments of the present system including the development of the present high-frequency AC current heating systems.

In this model in accordance with embodiments of the present system, the resistor Rₑ represents the electrical resistance against electrons from freely moving in conductive materials with which the electrodes and wiring are fabricated. The equivalent resistor Ri(f) and Li(f) represent the temperature and frequency (f) dependent resistance to free movement of ions and their resistance to acceleration due to their mass, ion-ion and charge interactions, etc., respectively. The capacitor Cₛ is the surface capacitance, which can store electric field energy between electrodes, acting like parallel plates of capacitors. The resistor R_{c} and capacitor C_{c} represent the electrical-chemical mechanism of the battery in which C_{c} is intended to indicate the electrical energy that is stored as chemical energy during the battery charging and that can be discharged back as electrical energy during the battery discharging, and R_{c} indicates the equivalent resistance to discharging current. The terminals A and B indicate the terminals of the battery.

The operation of a battery, such as a Li-ion battery used here as an example, as modeled in FIG. 4 in accordance with embodiments of the present system, may then be described as follows. If an AC current with high enough frequency is applied to the battery, due to the low impedance of the capacitor Cs, there will be no significant voltage drop across the capacitor, i.e., between the junctions C and D, and the circuit effectively behaves as if the capacitor Cs were shorted. As a result, the applied high-frequency AC current essentially passes through the resistors Rₑ and Rᵢ and inductor Lᵢ and not through the R_{c} and C_{c} branch to damage the electrical-chemical components of the battery. Any residual current passing through the R_{c} and C_{c} branch would not damage the battery due to its high-frequency and zero DC component.

The resistance Rₑ is very small in batteries and would generate negligible amount of heat. However, at any given temperature, the frequency dependent Rᵢ (f), which is shown below to increase rapidly with increased frequency of the applied current to generate heat in the battery electrolyte at a rate that is proportional to the square of the applied RMS current. The proposed technology in accordance with embodiments of the present system utilizes this process for direct heating of a battery electrolyte at a very high rate without causing any damage. It is also noted that since the electrical-chemical components of the battery are effectively bypassed, the applied high AC current and related voltage can be higher than those rated for the battery without causing any damage. The temperature and frequency dependent Lᵢ cause a phase shift between the applied high-frequency current and voltage to the battery, which due to the nonlinear nature of the electrolyte behavior, cannot provide information about the power loss inside the battery (battery heating) as shown in the following portion in accordance with embodiments of the present system.

### B) Direct Battery Electrolyte Heating at Low Temperature in Accordance with Embodiments of the Present System

To describe the developed direct battery electrolyte heating technology, consider a Lithium-ion battery. The basic operation of the battery may be approximately modeled with the equivalent (lumped) circuitry illustratively shown in FIG. 4 in accordance with embodiments of the present system.

In this illustrative novel model, the resistor Rₑ is considered to be the electrical resistance against electrons from freely moving in conductive materials with which the electrodes and wiring are fabricated. The equivalent resistor Ri and Li represent the resistance to free movement of Lithium ions by the battery electrolyte and equivalent inductance of the same, respectively. The capacitor Cₛ is the surface capacitance, which can store electric field energy between electrodes, acting like parallel plates of capacitors. As discussed, the resistor R_{c} and capacitor C_{c} represent the electrical-chemical mechanism of the battery in which C_{c} is intended to indicate the electrical energy that is stored as chemical energy during the battery charging and that can be discharged back as electrical energy during the battery discharging, and R_{c} indicates the equivalent resistance in which part of the discharging electrical energy is consumed (lost) and essentially converted to heat. The terminals A and B indicate the terminals of the Lithium-ion battery.

In the Li-ion model of FIG. 4 in accordance with embodiments of the present system, the components Rᵢ, R_{c} and C_{c}, are highly sensitive to temperature. At low temperature, the resistance of the resistor Rᵢ increases due to the increase in the “viscous” resistance of the electrolyte to the movement of lithium ions. This increase in resistance causes higher losses during charging and discharging of the Li-ion battery. Low temperature charging passes (relatively high) currents through the indicated components R_{c} and C_{c} and it is well known that such low temperature charging results in so-called lithium plating, which is essentially irreversible, prevents battery charging and permanently damages the battery.

The operation of the Li-ion battery, as modeled in FIG. 4 in accordance with embodiments of the present system, may then be described as follows. If an AC current with high enough frequency is applied to the battery, due to the low impedance of the capacitor Cₛ, there will be no significant voltage drop across the capacitor, i.e., between the junctions C and D, and the circuit effectively behaves as if the capacitor Cₛ were shorted. As a result, the applied high frequency AC current essentially passes through the resistors Rₑ and Rᵢ and inductor Lᵢ and not through the R_{c} and C_{c} branch to damage the electrical-chemical components of the battery. Any residual current passing through the R_{c} and C_{c} branch would also not damage the battery due to its high frequency and zero DC component of the applied current. The high frequency AC current passing through the resistors Rₑ and Rᵢ and inductor Lᵢ will then heat the battery core, thereby increasing its temperature. If the high frequency AC current is applied for a long enough period, the battery core temperature will rise enough to make it safe to charge using the commonly used DC current charging methods.

It is appreciated that inductance Lᵢ in the model of FIG. 4 in accordance with embodiments of the present system can only be assumed to be constant at relatively low passing AC current frequencies. This is the case since for a given AC current level, as the frequency of the passing current increases, the increase in the speed of the ionic “oscillatory” motions in the battery electrolyte would increase the heat loss across the modeled inductance Lᵢ in FIG. 4 in accordance with embodiments of the present system. This has been shown in accordance with embodiments of the present system to be the case for LI-ion and lead-acid battery experiments, the results of one such experiment with a lead-acid battery is illustratively discussed herein.

### C) Battery Characteristics as Function of Frequency in Accordance with Embodiments of the Present System

In this experiment in accordance with embodiments of the present system, a lead-acid battery voltage and current characteristics were measured over a frequency span range from 1 kHz to 70 kHz.

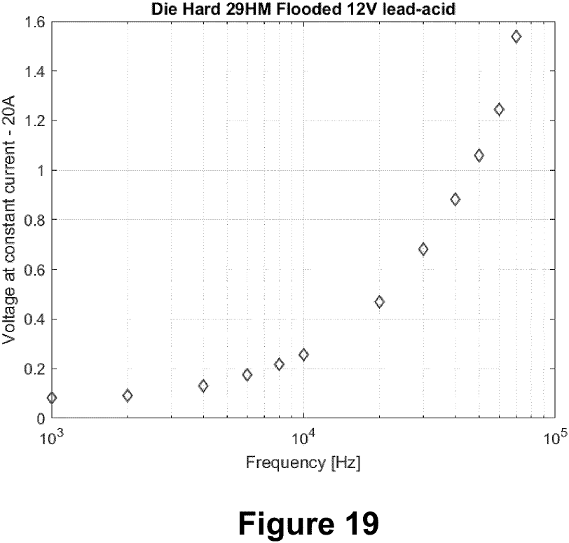

A 12 V flooded lead acid battery (Die Hard model #29-HM, m= 27.1 kg and capacity=65 Ah) was used in this experiment in accordance with embodiments of the present system. FIG. 19 shows the voltage response of the battery as a function of frequency at a constant current of 20 A.

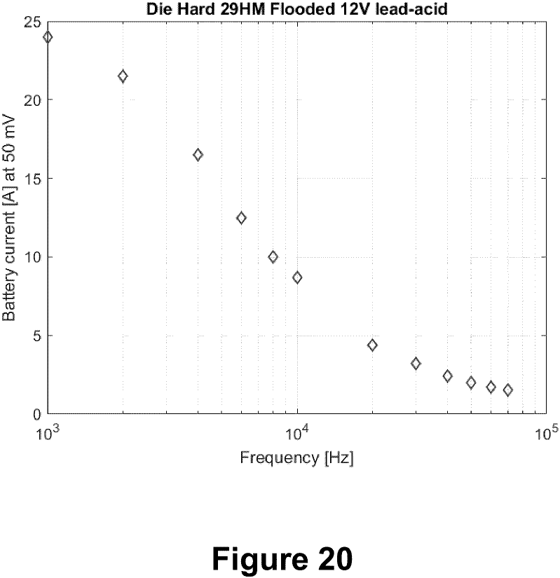

FIG. 19 shows battery current as a function of frequency with battery voltage held (e.g., the current response at a constant voltage of 50 mV). In FIG. 20, the indicated voltage is its increase about the battery voltage of 12 V. Both current and voltage are measured at the battery terminals.

### D) High-Frequency Circuit Model for Direct Battery Electrolyte Heating in Accordance with Embodiments of the Present System

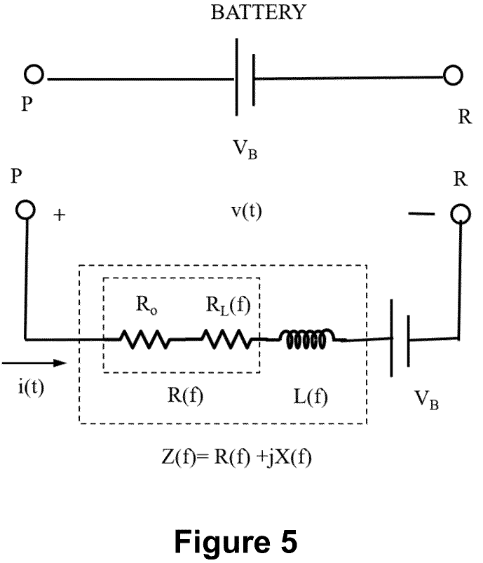

Based on the above discussion of high frequency heating, a first order electric circuit model must include a frequency dependent heating element as well as an inductive component accounting for the phase shift between the driving AC voltage applied between the battery terminals and the AC current flowing in the electrolyte. One such electric circuit model is illustrated in FIG. 5.

In an experiment in accordance with embodiments of the present system, lead-acid battery voltage and current characteristics were measured over a frequency span range from 1 kHz to 70 kHz. A 12 V flooded lead acid battery (Die Hard model #29-HM, m= 27.1 kg and capacity=65 Ah) was used in this experiment. FIG. 19 shows the voltage response of the battery as a function of frequency at a constant current of 20 A. FIG. 20 is the current response at a constant voltage of 50 mV. In FIG. 20, the indicated voltage is its (i.e., the indicated voltages) increase about the battery voltage of 12 V. Both current and voltage are measured at the battery terminals.

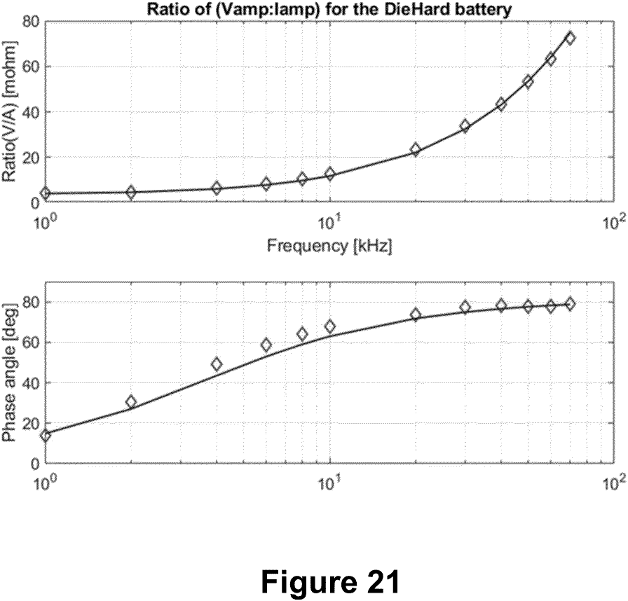

The measured voltage and current data of FIGS. 19 and 20 were then used to extract the amplitude ratio of the voltage and current and the phase angle (leading) between the measured voltage and current waveforms. The response obtained from both data sets (voltage vs. frequency and current vs. frequency) were identical and the plots from the constant voltage test are shown in FIG. 21.

As can be seen in the plots of FIG. 21, as the frequency is increased, the phase shift is increased and approaches 90 degrees, which means that the battery is exhibiting the characteristics of an “inductive” element. However, as it is shown herein this section, when an AC current with a constant amplitude is applied to the battery, as the current frequency is increased, the amount of heat that is generated inside the battery is increased. This indicates that if we want to develop a model to represent the battery heating process due to high frequency current, the first order approximation of such a model should look as shown in the diagram of FIG. 5. It should be noted that terms such as “resistance” and “inductance” are borrowed from the electric circuit terminology for convenience.

In the model of FIG. 5, R₀ is the resistance component that is constant (possibly mostly due to the conductive components of the battery) and R_{L}(f) is the frequency dependent resistance component of the battery, which is due to the oscillatory motion of the ions inside the battery electrolyte. The frequency dependent resistance R_{L}(f) is therefore expected (and verified as shown herein this disclosure) to increase with frequency up to a certain frequency and begin to drop with further increase in the frequency. The more detailed study of the above phenomenon is underway, and the results will be presented in future publications.

Borrowing the terms “resistance” and “inductance” from the electric circuit terminology, the model of FIG. 5 includes a non-frequency dependent “resistor” Rₒ, and a frequency dependent “inductor” and a frequency dependent “resistor”.

The model of FIG. 5 includes a non-frequency dependent resistor Ro, and a frequency dependent inductive reactance X(f) and a frequency dependent resistor R(f). The battery “impedance” Z(f) is therefore given by

$$\text{Z} \left(\text{f}\right) = \text{R} \left(\text{f}\right) + \text{jX} \left(\text{f}\right) \qquad \text{(1)}$$

Using the first order approximation, R(f) and X(f) can be expressed as,

$$\text{R} \left(\text{f}\right) = \left[{\text{P}}_{0} + {\text{P}}_{1} \text{f}\right] \text{and X} \left(\text{f}\right) = {\text{P}}_{2} \text{f} \qquad \text{(2)}$$

where f is the frequency in Hz, P₀ is the resistance in mΩ at f=0 and P₁ and P₂ are constant coefficients with units, which are determined by fitting to the experimentally measured frequency scan data for the battery of interest described below.

The voltage v(t) and the current i(t) at the battery terminals as illustratively shown in FIG. 5 are given by:

$$\text{v} \left(\text{t}\right) = {\text{V}}_{\text{o}} \text{cos} \left(2 π \text{ft} + {θ}_{\text{v}}\right) \text{and i} \left(\text{t}\right) = {\text{I}}_{o} \text{cos} \left(2 π \text{ft} + {θ}_{i}\right) \qquad \text{(3)}$$

where Vo and θᵥ are the amplitude and phase angle of the voltage and Iₒ and θᵢ are the amplitude and phase angle of the current waves, respectively. The DC voltage term corresponding to the battery voltage is excluded from the equation. Using phasor notation, the battery “impedance” Z(f) is expressed in terms of its magnitude and phase.

$$\left|\text{Z} \left(\text{f}\right)\right| = \sqrt{{\text{R}}^{2} \left(\text{f}\right) + {\text{X}}^{2} \left(\text{f}\right)} = \sqrt{{\left({\text{P}}_{0} + {\text{P}}_{1} \text{f}\right)}^{2} + {\left({\text{P}}_{2} \text{f}\right)}^{2}} \qquad \text{(4)}$$

$$Φ \left(\text{f}\right) \left[\text{deg}\right] = \frac{180}{π} {tan}^{\text{-1}} \left[\frac{\text{X} \left(\text{f}\right)}{\text{R} \left(\text{f}\right)}\right] = \frac{180}{π} {tan}^{\text{-1}} \left[\frac{{\text{P}}_{2} \text{f}}{\left({\text{P}}_{0} + {\text{P}}_{1} \text{f}\right)}\right] \qquad \text{(5)}$$

Either equation (4) or equation (5) can be used to obtain the unknown coefficients P₀, P₁ and P₂, through a non-linear least squares curve fitting technique. Alternatively, equation (2) for R(f) and X(f) can also be used to obtain the unknown parameters. The process of obtaining these parameters for any battery at a given battery temperature is described below.

Either equation (4) or equation (5) can be used to obtain the unknown coefficients P1 and P2, for example, through a non-linear least squares curve fitting technique. Using equation (5) for fitting to the phase data in FIG. 9, the unknown coefficients are calculated as P₁=0.155x10⁻³ mΩ /Hz and P₂=1.05x10⁻³ mΩ/Hz. The solid line shows the fit obtained. These recovered parameters P₁ and P₂ were used to obtain the solid line in the (V/I) ratio (i.e., IZ(f)1) plot of FIG. 9.

During heating at a given battery temperature, the RMS current I, flowing through the frequency dependent “resistor” R(f) of the battery generates heat due to the absorbed power I²R(f). It should be noted that R(f) is fictitious and is used to describe the first order heating effect due to the oscillatory motion of the ions in the electrolyte and the electrolyte medium resistance to the motions, and interactions between the ions. The absorbed power, indicated as P(f, I), can then be expressed as

$$\text{P} \left(\text{f,} \text{I}\right) = {\text{I}}^{2} \text{R} \left(\text{f}\right) = {\text{I}}^{2} \left[{\text{P}}_{0} + {\text{P}}_{1} \text{f}\right] {\text{x10}}^{\text{-3}} \left[\text{W}\right] \qquad \text{(6)}$$

where R(f) = (P₀ + P₁ f) and the unknown P coefficients for any battery which are to be determined.

This absorbed power in the battery raises the temperature of the battery electrolyte and based on its mass m (kg), specific heat capacity Cₚ (J.kg⁻¹.°C⁻¹) and duration t (s). The increase in temperature ΔT (°C) is thereby given by

$$Δ \text{T} = \frac{\text{P} \left(\text{f,} \text{I}\right) \text{t}}{{\text{C}}_{\text{p}} \text{m}} \qquad \text{(7)}$$

By defining a battery dependent parameter

$$β = {\text{mC}}_{\text{p}} \qquad \text{(8)}$$

the heating rate HR (°C/s) can be obtained by combining equations (6), (7) and (8) as

$$\text{HR} \left(\text{f,} \text{I}\right) = \frac{Δ \text{T}}{\text{t}} = \frac{1}{β} {\text{I}}^{2} \left[{\text{P}}_{\text{o}} + {\text{P}}_{1} \text{f}\right] \left[° \text{C} / \text{s}\right] \qquad \text{(9)}$$

Using the equations above in the experiment in accordance with embodiments of the present system for the 12 V flooded lead acid battery used and the measured data, the following can be derived:

$$\text{R} \left(\text{f}\right) = \left[{\text{R}}_{0} + {\text{P}}_{1} \text{f}\right] \text{and X} \left(\text{f}\right) = {\text{P}}_{2} \text{f} \qquad \text{(2.1)}$$

where f is the frequency in Hz, R₀ is the resistance in mW, and P₁ and P₂ are constant coefficients with units [mΩ /Hz] and [mΩ /Hz], respectively, which are to be determined by fitting the data provided by the plots of FIG. 9. For the present battery, the resistance Rₒ was measured to be Rₒ = 3.8 mΩ using the DC step method.

Using phasor notation, the battery “impedance” Z(f) is expressed in terms of its magnitude and phase

$$\left|\text{Z} \left(\text{f}\right)\right| = \sqrt{{\text{R}}^{2} \left(\text{f}\right) + {\text{X}}^{2} \left(\text{f}\right)} = \sqrt{{\left(3.8 + {\text{P}}_{1} \text{f}\right)}^{2} + {\left({\text{P}}_{2} \text{f}\right)}^{2}} \qquad \text{(4.1)}$$

$$Δ \text{f} \left[\text{deg}\right] = \frac{180}{π} {tan}^{\text{-1}} \left[\frac{\text{X} \left(\text{f}\right)}{\text{R} \left(\text{f}\right)}\right] = \frac{180}{π} {tan}^{\text{-1}} \left[\frac{{\text{P}}_{2} \text{f}}{\left(3.8 + {\text{P}}_{1} \text{f}\right)}\right] \qquad \text{(5.1)}$$

Either equation (4) or equation (5) can be used to obtain the unknown coefficients P1 and P2, for example, through a non-linear least squares curve fitting technique. Using equation (5) for fitting to the phase data in FIG. 9, the unknown coefficients are calculated as P₁=0.155x10⁻³ mΩ /Hz and P₂=1.05x10⁻³ mΩ/Hz. The solid line shows the fit obtained. These recovered parameters P₁ and P₂ were used to obtain the solid line in the (V/I) ratio (i.e., |Z(f)|) plot of FIG. 9.

During heating, the RMS current I, flowing through the frequency dependent “resistor” R(f) of the battery generates heat due to the absorbed power I²R(f). The absorbed power, indicated as P(f, I), can then be expressed as

$$\text{P} \left(\text{f,} \text{I}\right) = {\text{I}}^{2} \text{R} \left(\text{f}\right) = {\text{I}}^{2} \left[3.8 + {\text{P}}_{1} \text{f}\right] {\text{x10}}^{\text{-3}} \left[\text{W}\right] \qquad \text{(6.1)}$$

where R(f) = (Ro + P₁ f) and R₀= 3.8 x 10⁻³ Ohm.

Now defining β as expressed in equation (8) and replacing the above values for m and Cₚ for the present battery, we get

$$β = \frac{{\text{mC}}_{\text{P}}}{60} = \frac{\left(27.1 \text{kg}\right) \left(727.1 {\text{Jkg}}^{\text{-1}} . ° {\text{C}}^{\text{-1}}\right)}{60} = 328.5 \text{W} / \left(° {\text{C}}^{- 1} / \text{min}\right) \qquad \text{(8.1)}$$

The heating rate HR (°C/min) is then obtained by dividing equation (7) by time (which is now in minutes) and using β as expressed in equation (8.1) to get

$$\text{HR} \left(\text{f,} \text{I}\right) = \frac{Δ \text{T}}{\text{t}} = \frac{1}{β} {\text{I}}^{2} \left[{\text{R}}_{\text{o}} + {\text{P}}_{1} \text{f}\right] \left[° \text{C} / \text{min}\right] \qquad \text{(9.1)}$$

Now substituting the values of R₀, P₁ and β into equation (9.1), the heating rate for the tested battery becomes

$$\text{HR} \left(\text{f,} \text{I}\right) = 3.04 {\text{x10}}^{- 6} \left[3.8 + 0.155 {\text{x10}}^{- 3} \text{f}\right] {\text{I}}^{2} \left[° \text{C} / \text{min}\right] \qquad \text{(10)}$$

where f is in Hz and I is the rms current in A.

It should be noted that the heating model in accordance with embodiments of the present system expressed in equation (10) is derived from the battery characterization using sinusoidal current and voltage waveforms.

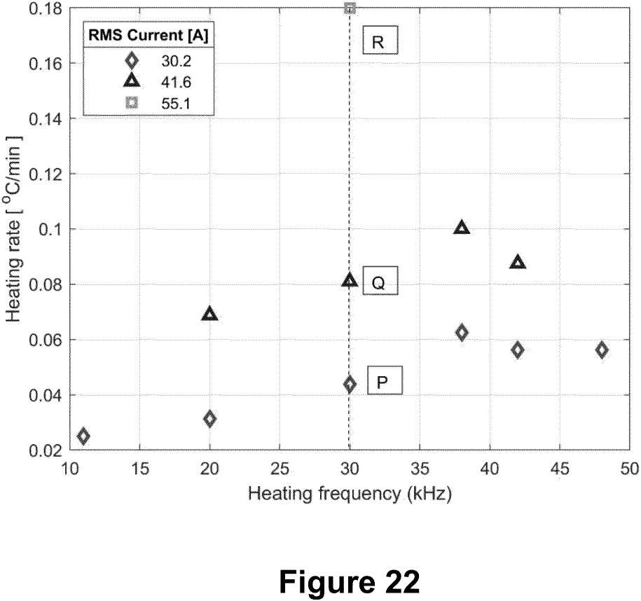

To verify the high frequency heating model shown in FIG. 5 and the derived heating rate equation (10), heating measurements were performed on the 12 V flooded lead acid battery using the high frequency heating system that applies a prescribed AC current with a selected frequency in accordance with embodiments of the present system. Measurements were performed on the uninsulated battery at room temperature. At constant heating currents, the internal temperature of the battery (monitored by a thermocouple mounted in the electrolyte) was recorded over a time duration of 10 mins to 16 mins. The heating rate HR (°C/min) was obtained from the temperature difference at the start and end of the test. FIG. 22 shows the plot of the heating rate as a function of frequency for the indicated AC currents.

The equation (10) is then used to calculate the heating rates at the currents of points P, Q and R, FIG. 5, i.e., at 30.2, 41.6 and 55.1 A, respectively, and compared the results with the measured values at those points.

At the point P, FIG. 22, the measured heating rate is 0.044° C./min with I=30.2 A and f = 30 kHz. From equation (10) and including the required scaling factor of

$$\sqrt{3}$$

(for the triangularshaped applied current at frequencies above 10 KHz), the heating rate is calculated to be 0.041° C./min as shown below:

$$\text{HR} \left(\text{f,} \text{I}\right) = \sqrt{3} \text{x 3} {\text{.04x10}}^{- 6} \left[3.8 + 0.155 {\text{x10}}^{- 3} \text{f}\right] {\left(30.2\right)}^{2} = 0.041 \left[° \text{C} / \text{min}\right]$$

The measured heating rates at points Q and R in FIG. 22 are 0.10° C./min with I=41.6 A and 0.18° C./min with I=55.1 A, respectively, at the current frequency of f = 30 kHz. The corresponding calculated heating rates were then similarly obtained using equation (10) as 0.08° C./min and 0.14° C./min at points Q and R, respectively.

Considering the limitations of the above tests, the results clearly confirm the validity of the high frequency battery heating model of FIG. 5 in accordance with embodiments of the present system and validate the use of high frequency currents to heat the battery from the inside. Within the range of currents used in the tests (30 A to 55 A); equation (10) is a good predicator of the heating rate for the flooded lead acid battery.

### Example: Direct Heating of a Li-Ion Battery at Low-Temperature in Accordance with Embodiments of the Present System

As an example of the presented high frequency heating method in accordance with embodiments of the present system as applied to Li-ion batteries, for example, such as a single 18650 Li-ion battery cell, which was heated from different low temperatures to 20° C. using a high frequency AC heating circuitry in accordance with embodiments of the present system.

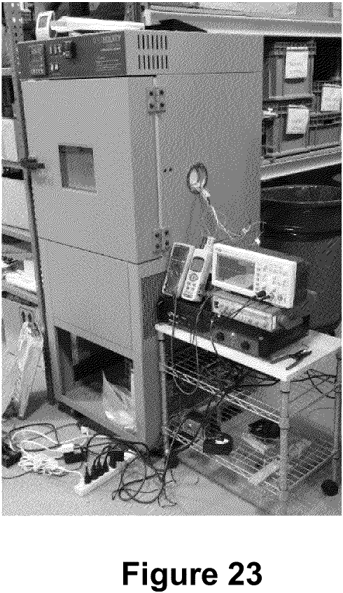

The battery was wrapped in a layer of 0.25” thick ceramic Fiberfrax insulation and kept in an environmental chamber, which was kept at the selected low temperature level during the test. Two thermocouples were used to measure the surface temperature of the battery during the test. The Li-ion battery electrolyte AC voltage heating test set-up is shown in FIG. 23. The peak AC heating current was kept at 14 A and at a frequency of 10 KHz. It is noted that even the AC voltage of the high frequency signal used for heating the electrolyte can be significantly higher than the rated voltage of the battery.

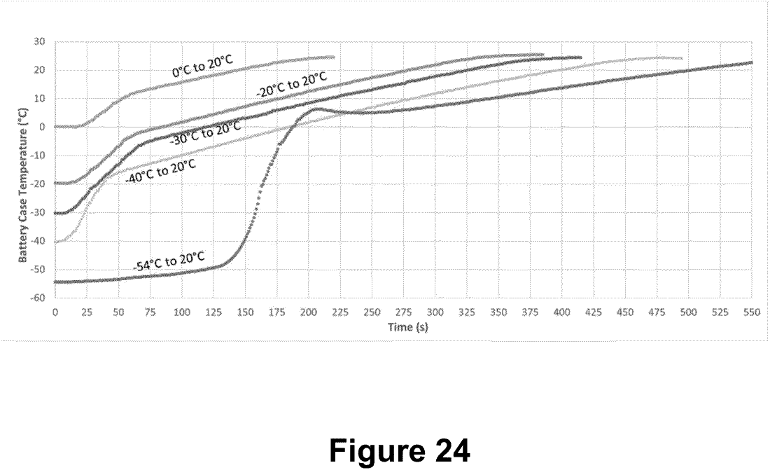

The plots of electrolyte heating of the Li-ion battery cell as measured by the battery surface temperature as a function of time are shown in FIG. 24.

It is noted that a wide range of low temperature heating tests in accordance with embodiments of the present system have been successfully conducted on Li-ion, Li-polymer and Lead-acid batteries and super-capacitors without causing any damage to the units.

The development in accordance with embodiments of the present system provides a novel technology for direct and rapid heating of battery electrolyte at low temperatures and maintaining the battery temperature at its optimal performance level.

The methods and devices (systems) in accordance with embodiments of the present system for direct and rapid heating of battery electrolyte at low temperatures and maintaining the battery temperature at its optimal performance level has been extensively tested on a wide range of primary and secondary batteries at temperatures as low as -54 deg. °C without causing any damage to the batteries. The technology is applicable to almost all primary and secondary batteries, such as Lithium-ion, Lithium-polymer, NiMH and lead-acid batteries. The technology in accordance with embodiments of the present system is also applicable to super-capacitors and has been used to rapidly heat super-capacitors at temperatures as low as -54 deg. °C without any damage.

The technology in accordance with embodiments of the present system is based on the identified frequency dependence of the response of batteries to AC current. Based on the findings presented herein, a more representative model of batteries in accordance with embodiments of the present system that are subjected to high frequency current has been illustrated and validated experimentally. Similar tests that are presented for a lead-acid battery has also been performed in accordance with embodiments of the present system on Li-ion batteries with similar results, confirming that the source of the frequency dependent “resistance” shown in the developed model in accordance with embodiments of the present system should be the ionic oscillatory motion in the electrolyte.

### E) Validation of the High-Frequency Circuit Model in Accordance with Embodiments of the Present System for Heating

The high-frequency circuit model of FIG. 5 and the derived heating rate equation (9) in accordance with embodiments of the present system for battery heating were validated as described below using a Li-ion battery model RCR123A. This is a 3.7 V (800 mAh) cylindrical cell, which is 17 mm in diameter and 34.5 mm in length.

### Determining the Model Parameters in Accordance with Embodiments of the Present System

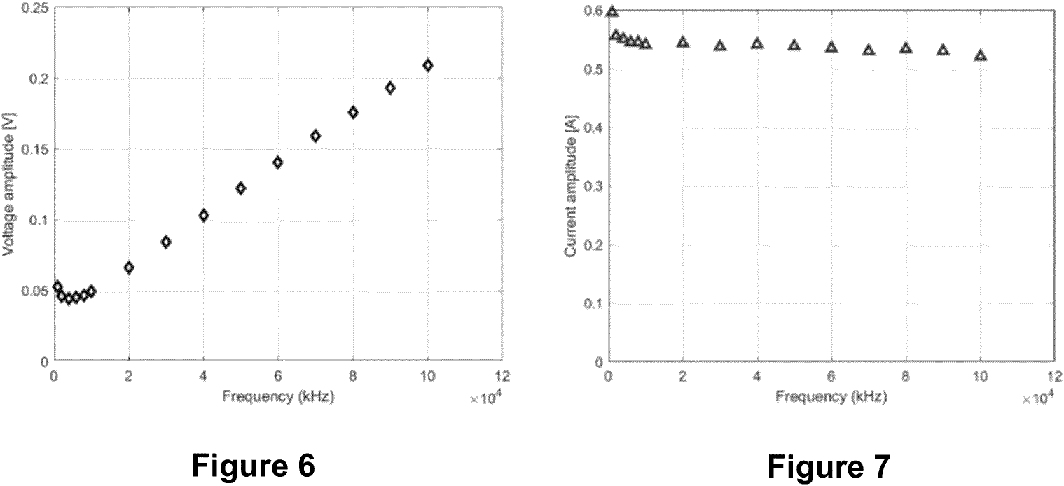

The frequency response of the above test battery at room temperature (20° C.) was characterized over a range of frequencies from 1 kHz to 100 kHz by driving the battery with a low amplitude AC sinusoidal current signal. Both the applied AC current and the corresponding AC voltage were measured at the applied frequency. The voltage and current data from the entire frequency scan was processed to extract the ratio of the voltage to current amplitudes and the phase shift between the voltage and current waveforms. FIGS. 6 and 7 show the measured voltage and current amplitudes across the above frequency sweep, respectively.

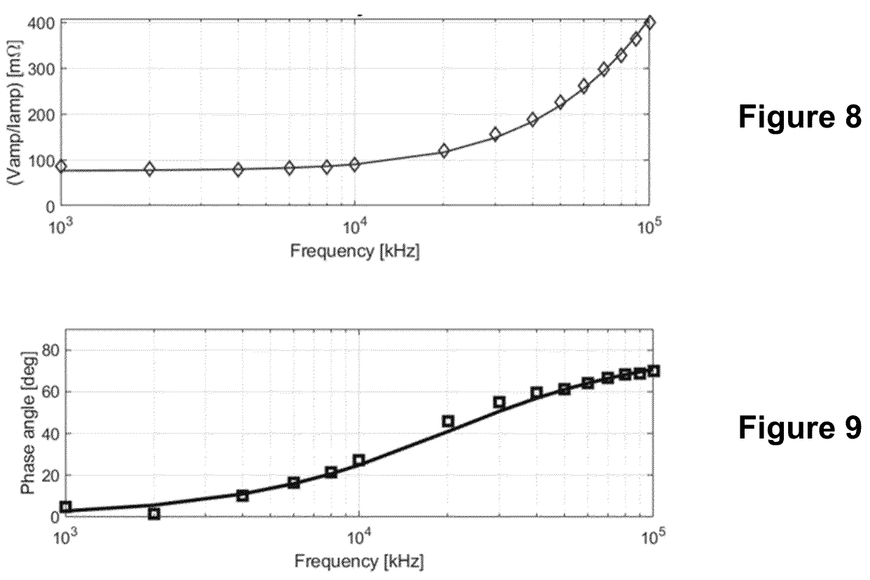

The voltage and current data of the plots of FIGS. 6 and 7 are then combined to extract the amplitude ratio of the voltage and current, which is plotted in FIG. 8. The phase angle (leading) between the voltage and current waveforms of FIG. 9 was extracted directly from voltage and current waveforms.

As can be seen in the plots of FIGS. 8 and 9, as the frequency is increased, the phase shift is increased and approaches 90 degrees, which means that the battery is exhibiting the characteristics of an equivalent non-ideal inductive element. This is exactly the behavior predicted by equations (4) and (5), which include an equivalent frequency dependent heating element R(f) and an ideal reactive inductance X(f) (=2πfL).

The data in FIGS. 8 and 9 is then combined to extract data of the corresponding R(f) and X(f). Using the corresponding models expressed in equation (2), unknown model coefficients P₀ and P₁ are extracted by fitting to R(f) data and coefficient P₂ is obtained by fitting to X(f) data. Subsequently, the unknown coefficients are found to be Po=77.5 mΩ, P₁=5.863x10 ″ ⁴ mΩ/Hz and P₂=3.9x10⁻³ mΩ/Hz for the tested battery. The solid lines in FIGS. 8 and 9 show the fitted curves obtained using these parameters in equations (4) and (5). It is appreciated that the above parameters are for the battery at room temperature.

### Determining the Heat Rate HR(I,f) in Accordance with Embodiments of the Present System

At a given temperature, the frequency and current dependent heat rate equation (9) is then obtained for the tested RCR123 Li-ion battery by using the above model coefficients, combined with the knowledge of the physical characteristics of the tested battery. In the case of the tested RCR123A Li-ion, the mass m=0.018 kg and the specific heat capacity is Cₚ =800 J/(kg°C). Using these values, the battery dependent parameter β, equation (8), becomes

$$β = {\text{mC}}_{\text{P}} = \left(0.018 \text{kg}\right) \left(800 {\text{Jkg}}^{\text{-1}} . ° {\text{C}}^{\text{-1}}\right) = 14.4 \text{J} \text{.} ° {\text{C}}^{\text{-1}} \qquad \text{(11)}$$

It should be noted that the value Cp is an approximation, based on range of values (700 to 900) found in the literature. Now substituting the values of P0, P1 and β into equation (9), the heating rate for the tested battery (RCR123) at room temperature is given as

$$\text{HR} \left(\text{f,} \text{I}\right) = 6.95 {\text{x10}}^{- 5} \left[77.5 + 0.586 {\text{x10}}^{- 3} \text{f}\right] {\text{I}}^{2} \left[° \text{C} / \text{s}\right] \qquad \text{(12)}$$

where f is in Hz and I is the RMS current in A.

Test Results for the RCR123A Battery

The experimental data reported below was acquired using the following facilities and equipment. All low temperatures tests were performed in the Test Equity Temperature Chamber Model #115A, AC battery current was measured using a Rogowski current probe (PEMUK CWT/15/B), and AC battery voltage was measured using a Keysight differential voltage probe (#N2791A). Battery temperature was measured using a J-Type thermocouple (#SRTC-TT-K-20-36) and the temperature profile recorded using a DigiSense logger (#20250-03). As it was not possible to mount a thermocouple inside the test battery (RCR123A), it was mounted on the outer surface of the battery, midway along its length and insulated from the ambient convection heat transfer with a 3 mm thick patch of Fiber Frax 3 mm sheet (produced by Unifrax Corporation).

The heating rate equation (12) was validated by performing measurements on Li-ion test battery RCR123A, which has a voltage of 3.7 V and capacity of 800 mAh. Other presented battery heating tests were also performed with the same type of battery.

At a given battery temperature, the heating rate equation (12) is proportional to both the square of the RMS value and the frequency of the AC heating current. These two dependencies were evaluated independently as described below.

### Heating Rate as a Function of the AC Current Frequency in Accordance with Embodiments of the Present System

To verify the frequency dependence of the heating rate as described by equation (12), measurements were performed on one of the aforementioned RCR123A batteries placed in the open room environment. AC heating current over a range of frequencies from 1 kHz to 100 kHz was injected into the battery at an RMS amplitude of 4 A at all frequencies. The battery temperature was measured before and after injecting the AC heating current for 90s. The heating rate HR (°C/min) was obtained from the temperature difference at the start and end of the heating duration.

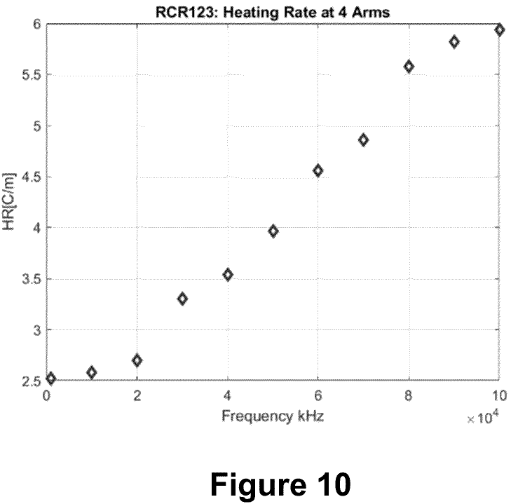

FIG. 10 shows a plot of the heating rate at room temperature of a RCR123A Li-ion battery as a function of the AC heating current frequency at a constant RMS value of 4 A.

FIG. 10 confirms that the heat generated by high-frequency AC currents in the battery electrolyte increases rapidly with increasing frequency. The heat generated due to the ion-ion and ion and electrolyte medium interactions, is a non-linear phenomenon, which reaches a peak value at some high frequency, and beyond that frequency the heat generation is seen to begin to decrease. This phenomenon has not been studied in electrolytes and is expected to be due to the “gaps” generated between the ions and their charges and the electrolyte medium at high frequencies as the ions undergo oscillatory motion. The presence of a heating rate peak frequency is also shown in Lead-acid heating rate measurements as a function of frequency is presented herein this disclosure.

For the RCR123 Li-ion batteries tested, this optimal heating frequency was around 80 kHz, whereas the measurements with 12 V Lead-acid batteries show an optimal heating frequency of ~40 kHz. The Lead-acid data is presented herein this disclosure.

The measured heating rate is close to 3.9° C./min, which is close to the estimated heating rate of around 5° C./min (7° C./min minus the measured heat loss rate of 2° C./min).

### Validation of the Developed Heating Rate Model in Accordance with Embodiments of the Present System

For this test, the battery was wrapped in a Fiber Frax 3 mm sheet insulation and placed in an insulated box and placed in the environment test chamber. This testing arrangement minimized heat loss from the battery during heating. The heating rate test was then performed at a frequency of 80 kHz and at four different RMS AC current levels.

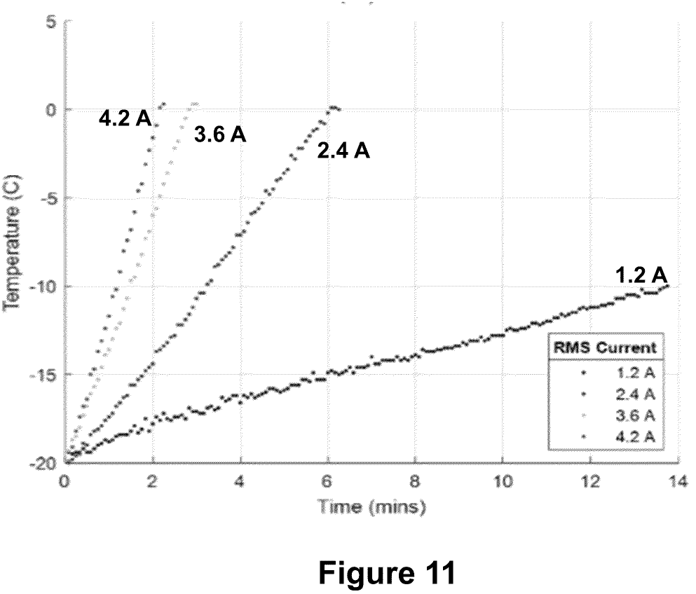

For each current level, the environment temperature was set to -20° C. and the battery was heated until the battery temperature reached 0° C. As the heating rate is nearly constant over the temperature of 0° C. to 20° C., the model parameters measured at room temperature could be used for the present model validation purposes. FIG. 11 shows the temperature profiles of the battery electrolyte temperature as a function of time for the four AC current amplitudes. The heating rates were calculated from the nearly linear heating profiles of FIG. 11.

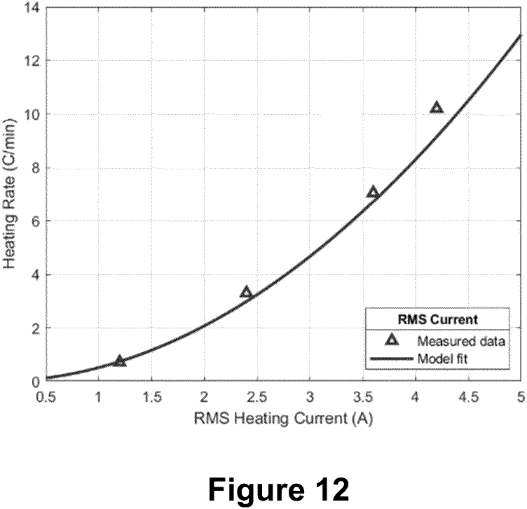

The heating rate data (symbols) as well as the heating rate calculated from the model (solid line), equation (12), are shown in the plot of FIG. 12. The measured data (symbols) is observed to show very good agreement with the predicted (solid line) heating rate described by equation (12).

### High-Frequency Direct Battery Electrolyte Heating Circuits Using an External Power Source in Accordance with Embodiments of the Present System

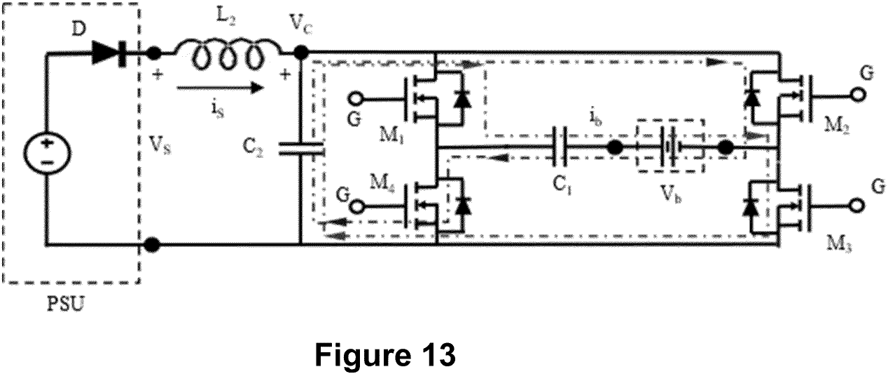

Several designs have been developed and tested. FIG. 13 shows an exemplary high-frequency heating circuit which uses a high-frequency heating circuit powered by an external power source such as an external single polarity DC power source. The circuit has been used for heating the present single cell RCR123A 3.7 V (800 mAh) Li-ion batteries as well as 36 V (850 Ah) Lead-acid batteries weighing 928 kg. It is noted that as it is described below, the high-frequency current being passed through the battery for electrolyte heating is symmetric, i.e., it has no net DC component.

The flow of oscillatory high-frequency heating currents, indicated by the dash-dot lines, are controlled by the conduction of MOSFET switches M1, M3 and M2, M4. Switching waveforms for the two banks of MOSFETs are generated by a microcontroller. The heating frequency is determined by the resonant frequency of the series RLC which is formed by the DC blocking capacitance C₁ and the combined inductance of the battery and the external components and connecting wires. The MOSFETs are switched OFF/ON at the zero crossings of the high frequency AC battery current. This approach minimizes the switching losses, increasing the efficiency of the heating circuit. Further improvements in circuit efficiency are attained by using a parallel array of low equivalent series resistance (ESR) AC coupling capacitors. Diode D prevents current flow back into the DC source, while inductor L₂ provides a soft start. The DC link capacitor C₂ is appropriately sized to meet the peak current demand of the high frequency heating circuit.

### High-Frequency Heating Circuit Powered by the Battery for “Self-Heating” in Accordance with Embodiments of the Present System

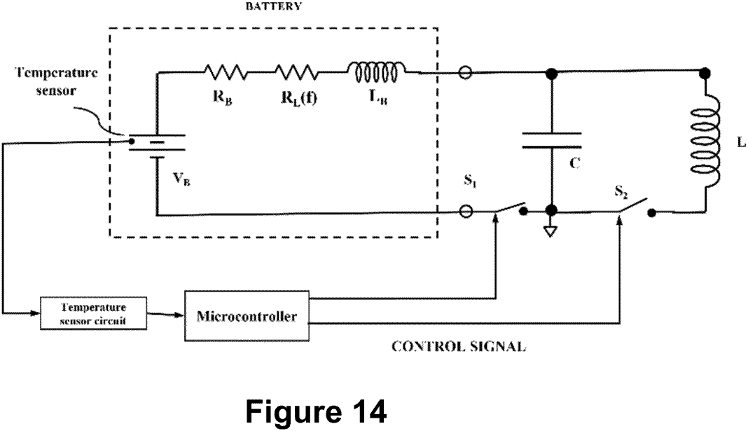

FIG. 14 shows a schematic of a self-heating circuit that has been tested for use with Li-ion and Lead-acid batteries. With reference to the circuit of FIG. 14, the circuit operation has two states, the first phase of the operation is enabled by closing switch S1 with S2 open. During this phase, a series RLC circuit is formed by the internal equivalent electric circuit components of the high-frequency model of batteries previously described and an external capacitance. The RLC circuit oscillates until the capacitor C reaches the battery voltage and the current flow ceases. The oscillating high-frequency current produces heat in the battery electrolyte. Selection of the external capacitance is a trade-off between the peak current amplitude and the required resonant heating frequency. The former is proportional to the square root of the capacitance while the latter is inversely proportional to the square root of C. In some cases, an external inductor is required to satisfy the dual requirements of the peak current and the heating frequency. In order, to restart the heating cycle, the charged capacitor C must discharge rapidly. Normally, the discharging can be performed by dumping the energy to an external load resistor. However, the design illustrated in FIG. 14 uses an inductor L to momentarily capture the energy in the capacitor by closing electronic switch S₂ and opening Sₗ. The energy is allowed to oscillate back and forth between C and L for one half cycle and then by appropriate timing, the inductor energy is returned to the battery at the start of the next heating cycle. This choregraphed dance results in a highly efficient self-heating circuit.

### Examples of High-Frequency Li-Ion CR123 Battery in Various Cold Temperature Environments in Accordance with Embodiments of the Present System

In the following examples, the results of tests on the aforementioned Li-ion CR123 batteries using the above high-frequency AC current battery heating circuits in accordance with embodiments of the present system are presented. The tests are performed as the confirmation of the efficacy of the present high-frequency AC current direct heating of battery electrolytes in cold as well as extreme cold environments. The batteries are placed in the environment chamber that was set to the desired low temperature and was left in the chamber for several hours to ensure that the entire battery body is at the set chamber temperature. The batteries were then heated with each one of the above circuits in accordance with embodiments of the present system until their surface temperature was measured to be at room temperature level of 20° C.

### High-Frequency Heating of a Li-Ion CR123 Battery Using an External Power Source in Accordance with Embodiments of the Present System

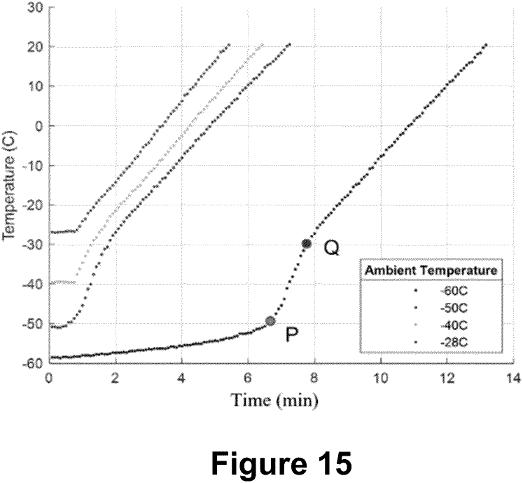

In these tests, a Li-ion CR123 battery was heated by high-frequency ac current in accordance with embodiments of the present system, which is powered by an external source, from the selected low temperatures until its surface temperature reached the room temperature level of 20° C. The tests were performed at starting environment chamber temperatures of -30° C., -40° C., -50° C., and -60° C. In each case, the battery was heated continuously using a high-frequency system comprising of a function generator, a linear amplifier, a step-down transformer, and a DC blocking capacitor in accordance with embodiments of the present system until the battery electrolyte temperature reached 20° C. The temperature profiles plots are shown in FIG. 15 and show very similar temperature response for all initial cold temperatures. At the extreme temperature environment of -60° C., the initial rise in battery temperature is slow until it reaches the point P, most likely due to the “frozen” electrolyte. Subsequently, following a “phase change” around -50° C. (P), the battery temperature begins to rise rapidly like the other three profiles. It is appreciated that in the latter case of the -60° C. initial battery temperature, the heating rate was limited by the ability of the heating circuit to source the required load current demand, which can be solved by allowing simple modification of the circuit in accordance with embodiments of the present system to provide higher voltage levels until the battery temperature has reached around -50° C., i.e., point P. Beyond the point Q, the high frequency heating circuit would again operate in the current limit mode, sourcing ~ 4 A.

### Maintaining a Li-Ion CR123 Battery at Room Temperature in a -60° C. Extreme Cold Environment in Accordance with Embodiments of the Present System

In this test, the test Li-ion CR123 battery was wrapped loosely with the aforementioned Fiber Frax 3 mm sheet to eliminate convective heat transfer and placed in the temperature environment. The environment temperature was dropped to -60° C. and the battery was heated periodically to maintain its core temperature between 18° C. and 20° C. using the same high-frequency battery heating system/method described for the heating rate tests of FIG. 15. To keep the battery temperature within the indicated 18° C. and 20° C. range, an average of around 92 J/minute was measured to have been supplied by the external power source.

### Maintaining the Battery Core at Room Temperature Using High-Frequency Self-Heating in Extreme Cold Environment of -60° C. in Accordance with Embodiments of the Present System

The self-heating feasibility test was performed on a serial connection of two CR123 LI-ion batteries, with an open circuit voltage of 8.3 V. During this test, the two batteries were connected in series for two reasons: (1) to demonstrate that battery heating is homogeneous even when the batteries are distributed, and (2) to enable the use of a self-heating test circuit developed in accordance with embodiments of the present system for a 12 V battery. The two batteries were loosely insulated by wrapping them in a Fiber Frax 3 mm sheet material and the self-heating test circuit. To determine the battery energy consumed in keeping the battery at a temperature of 20° C. ± 2° C., while the environment chamber was kept at -60° C., the two batteries were mounted in a holder and placed inside the environment chamber. Two separate thermocouples (marked as TB7 and TB8) were mounted on the surface of the two batteries to measure the temperature of each battery.

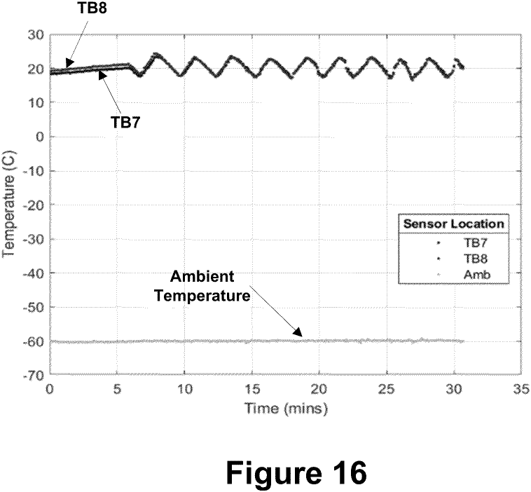

After installation in the environment chamber, the heating circuit in accordance with embodiments of the present system described for the heating rate tests of FIG. 15 with externally provided power was used to keep the battery at 20° C. as the chamber temperature dropped to -60° C. Once the environment temperature reached the set point of -60° C., the externally powered heating was stopped, and the self-heating circuit of FIG. 14 was enabled (heat ON) at a battery temperature of 18° C. and disabled at a battery temperature of 22° C. FIG. 16 shows that the self-heating circuit was holding the battery temperature at 20° C. +/- 2° C. FIG. 16 also shows that the output of the two battery temperature sensors (TB7 and TB8) are very close to each other, confirming that the two physically separated batteries are heated uniformly at the same rate.

This test clearly illustrates the capability of the disclosed technology in accordance with embodiments of the present system to provide a simple self-heating circuit to keep battery core temperature at room temperature or any other appropriate temperature in a very cold environment. In the present test, the batteries were initially fully charged and after self-heating for 25 minutes, the batteries were taken out of the environment chamber and were allowed to warm up to room temperature. The remaining battery capacity was then measured under load at the standard discharge current of 800 mA to 3.0 V. Calculations then showed that the battery temperature could have been maintained at 20° C. +/- 2° C. for around two hours via self-heating.

The above disclosed developed model of high-frequency current heating of battery electrolyte in accordance with embodiments of the present system, which applies to all primary and rechargeable batteries, including thermal and liquid reserve batteries, and super-capacitors; the experiments performed to validate the developed model; and the method of experimentally determining the parameters of the model for a given battery type and size, clearly shows that the developed high-frequency AC current direct electrolyte heating technology is fully capable of providing the means of keeping a battery temperature warm and within its optimal range of temperature to provide its maximum operating current and stored energy without any drop due to even extremely low environmental temperatures that may reach -60° C. The power for the high-frequency heating circuit may be provided from external sources or from the battery itself.

The following are the main characteristics and advantages of using the developed high-frequency AC current technology for direct heating of battery electrolytes, particularly for integration into various systems, and for use in almost any environment in which the temperature drops below the battery optimal operation and charging for rechargeable batteries, for example, below around 17° C. for Li-ion and Li-polymer and the like batteries, and particularly operation in cold and extreme cold environments:
The high-frequency AC heating method acts directly on the electrolyte’s ions, enabling fast heating of the entire liquid electrolyte volume inside the battery. The liquid electrolyte can then efficiently transfer heat to the rest of the internal battery components, such as electrodes, polymeric separator, and current collectors by thermal conduction. In this way, the heating occurs internally to the battery and very uniformly since the liquid electrolyte is everywhere, wetting all the internal elements of the battery. The result is a very uniform heating profile inside the battery with no hot spots or large thermal gradients, that could otherwise damage the liquid electrolyte or even start the thermal runway of the cathode electrodes.
The heating method does not require the modification or replacement of any internal components of the batteries, such as special low temperature electrolytes, new anode electrode materials, or others since it is implemented just through the addition of the external high AC frequency circuitry. Therefore, it is universally applicable to any existing primary and rechargeable battery, including Li-ion, Li-polymer, and so-called solid-state batteries and super-capacitors, any battery format and size as they are used in any existing system and device.
In extreme cold environments, wherein the electrolyte could completely freeze solid below -60° C., the imposed high frequency back-and-forth movement of the ions helps to completely redissolve the Lithium supporting salts back in the liquid electrolyte during the melting process. This will enable the batteries to be able to sustain multiple freezing-thawing cycles without losing discharge capacity.
The high frequency AC heating method is very energy efficient since almost all applied energy is used to heat up the electrolyte directly. Therefore, the amount of energy used from the battery to accomplish self-heating is minimum and only a small fraction of the battery capacity is used up in the process.
Internal temperature uniformity during heat up enables fast and precise feedback control with accurate temperature setpoint control. Controlling both charge and discharge temperature within an optimum narrow window maximizes battery cycle life.
The basic physics of the process and extensive tests clearly show that the high-frequency direct electrolyte heating would not damage or reduce battery life cycle. In fact, by using and charging batteries at their optimal temperature, their cycle life is significantly increased, and maximum amount of stored energy and current becomes available.
The high-frequency electrolyte heating circuit may either be powered by external sources and/or use the battery power for self-heating to maintain its core temperature at the optimal level.
The battery pack protection electronic units, such as those for Lithium-ion and Lithium-polymer batteries, can be readily modified to ensure continuous high-performance charging and operation at low temperatures.
Direct electrolyte heating requires significantly less electrical energy than external heating with heating pads or blankets or by internally provided electrical heating members.
Standard sized Li-ion or Li-polymer batteries can be used instead of thin and flat battery stack packaging to accelerate external heating via heating blankets or the like.
The technology is simple, uses commonly used electronic components, can be packaged in small volumes, and is low-cost.

In addition to the previously provided battery high-frequency AC current direct battery electrolyte heating test results, mainly on small CR123 LI-ion batteries for model validation and presentation of the method to determine model parameters through experimental measurement, two other results of tests of the applications of the high-frequency AC current direct battery electrolyte heating technology on a large Li-ion battery pack and a 928 kg Lead-acid battery pack used on lift trucks for operation in freezers at -25° C. are provided below.

### High-Frequency Heating of a Lead-Acid Battery (GNB M2701812515B) Used in Lift Trucks in Accordance with Embodiments of the Present System

A high-frequency AC current direct battery electrolyte heating circuit with the design shown in FIG. 13 using an external DC power source was designed to heat and maintain the battery electrolyte temperature in the range of 24° C. to 28° C. of a lift truck battery operating in a -25° C. freezer facility. The Lead-acid battery is 36 V with an 875 Ah capacity and weighs in at 928 kg.

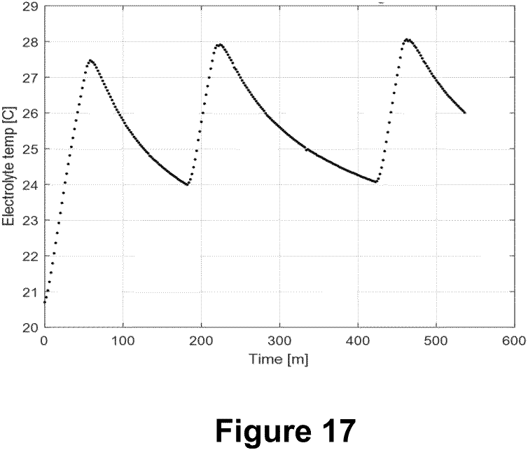

The high-frequency AC current direct battery electrolyte system was operated from a 6 V DC power source and heated at room temperature at a frequency of 30 kHz at an RMS current of 75 A. The heating was enabled when the battery temperature dropped to 24° C., and the heating was turned off when the battery reached 28° C. FIG. 17 shows the battery temperature profile over time. The measured heating rate was ~0.07° C./min.

### High-Frequency Heating of a Lead-Acid AGM Battery (ArmaSafe 6TAGM) Battery in Accordance with Embodiments of the Present System

A high-frequency AC current direct battery electrolyte self-heating circuit based on the circuit of FIG. 14 was used to heat a Lead-acid AGM battery (ArmaSafe 6TAGM). The battery was instrumented and together with the self-heating circuit board was placed in the environmental chamber. The battery temperature was maintained at -18° C. in the environment chamber temperature of -40° C. (a U.S. Army requirement for truck battery with the self-heating circuit. The high-frequency AC current direct electrolyte self-heating was used to maintain the battery temperature at -18° C. for 12 hrs. The battery was initially fully charged and after the 12 hr test, the battery was discharged to determine the percent of the total energy used during the above 12 hr test, which indicated that 25% of the available battery stored energy was used during the 12 hr test. It was then concluded that using 50% of the available stored energy in a fully charged battery, its temperature could be maintained at -18° C. in a -40° C. environment for around 24 hrs.

### Heating Rate of a 12 V Type 29HM Lead Acid Battery at Different AC Current Frequencies

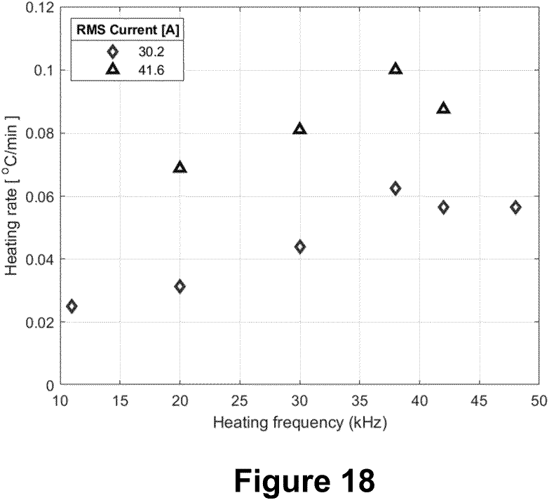

In this experiment, the objective was to verify the expected basic understanding of the physics of interaction between electrolyte ions and the electrolyte medium and between the ions, which is considered to be the mechanisms with which heat is generated when the ions are forced into high-frequency oscillatory motions. This heating mechanism suggests that the heating rate would increase with increased frequency — as was shown in the previously experimental results, but there should be a peak frequency for each battery type and size above which the heating rate would begin to drop. The reason for the drop is that above certain frequency, the high speed, and acceleration of the ions would form gaps between ions (similar to vacuum in fluids) and “impact” like interactions between the ions would reduce their number of such “impact” like interactions due to the generated gaps. Since this phenomenon can be seen at lower current frequencies in Lead-acid batteries due to the more liquid electrolyte, a 12 V Type 29HM lead acid battery was tested with constant RMS currents up to a frequency of 50 KHz. The result is shown in the plot of FIG. 18. As can be seen, a peak heating rate is reached around 37 KHz, after which the heating rate begins to drop. The same phenomenon is expected to be present in all battery electrolytes, including Li-ion batteries. Such tests are important to for all batteries to determine the peak heating rate heating current frequencies when the heating rate is desired to be maximized.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated but should be constructed to cover all modifications that may fall within the scope of the appended claims.

Further variations of the present system would readily occur to a person of ordinary skill in the art and are encompassed by the following claims.

Finally, the above discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art including using features that are described with regard to a given embodiment with other envisioned embodiments without departing from the broader and intended spirit and scope of the present system as set forth in the claims that follow. In addition, any section headings included herein are intended to facilitate a review but are not intended to limit the scope of the present system. In addition, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital portions;
g) any of the disclosed devices, features and/or portions thereof may be combined together or separated into further portions unless specifically stated otherwise;
h) no specific sequence of acts or steps is intended to be required unless specifically indicated; and
i) the term “plurality of” an element includes two or more of the claimed element, and does not imply any particular range of number of elements; that is, a plurality of elements may be as few as two elements, and may include an immeasurable number of elements.

What is claimed is:

1. A method for direct battery electrolyte and supercapacitor heating and temperature maintenance at low temperatures, the battery and/or supercapacitor having a core with an electrolyte having ions therein, the battery and/or supercapacitor having inputs, with one of the inputs having characteristics of a frequency-dependent resistor and inductor series coupled to a voltage source, the method comprising:
providing at least one power storage and source couplable to the one input configured to provide a positive input current and a negative input current at the one input when coupled to the one input;
determining a high frequency of alternating between the positive input current and the negative input current based on a heating efficiency of the high frequency on the battery and/or supercapacitor, and
controlling the at least one power storage and source to provide alternating between the positive input current and the negative input current at the high-frequency to substantially maximize an internal heating effect of the ions within the electrolyte of the battery and/or supercapacitor to generate heat and raise a temperature of the electrolyte.

2. A device for direct battery electrolyte and supercapacitor heating and temperature maintenance at low temperatures when coupled to a battery and/or supercapacitor having a core with an electrolyte having ions therein, the battery and/or supercapacitor having inputs, with one of the inputs having characteristics of a frequency-dependent resistor and inductor series coupled to a voltage source, the device comprising:
at least one power storage and source couplable to the one input, wherein the at least one power storage and source is configured to provide a positive input current and a negative input current at the one input when coupled to the one input; and
a controller configured to control the at least one power storage and source to provide alternating between the positive input current and the negative input current at the one input, wherein the controller is configured to control the at least one power storage and source to provide the alternating positive and negative input currents at a high-frequency configured to substantially maximize an internal heating effect of the ions within the electrolyte of the battery and/or supercapacitor to generate heat and raise a temperature of the electrolyte.

3. The device of claim 2, wherein the controller is configured to control the at least one power storage and source to discontinue the alternating positive and negative input currents when the temperature of the electrolyte, the battery and/or supercapacitor is within an operational temperature range of the battery and/or supercapacitor.

4. The device of claim 2, wherein the controller is configured to start the at least one power storage and source to provide the alternating positive and negative input currents at the one input when the temperature of the electrolyte and/or the battery and/or supercapacitor is lower than an operational temperature range of the battery and/or supercapacitor.

5. The device of claim 2, comprising a temperature sensor configured to provide a signal to the controller, wherein the signal is based on a sensed temperature of the electrolyte and/or a surface of the battery and/or supercapacitor, and wherein the controller is configured to start and stop the at least one power storage and source to provide the alternating positive and negative input currents at the one of the inputs in response to the signal.

6. The device of claim 2, comprising a switch, wherein the at least one power storage and source comprises a component configured to be charged by the voltage source through the one input, wherein the frequency-dependent resistor and inductor and the component are configured to operate as a series resonant circuit with the voltage source through operation of the switch, and wherein the controller is configured to control the switch to start and discontinue heating of the electrolyte.

7. The device of claim 6, wherein the switch is a first switch, the device comprising a second switch, coupled to the component, wherein the second switch is configured to initiate discharging of the component, and wherein the controller is configured to control the second switch to start and discontinue discharging of the component.

8. The device of claim 2, wherein the at least one power storage and source comprises a component configured to be charged by the voltage source through the one input, the device comprising a first switch, a second switch and an inductor parallel coupled to the component through closing of the second switch, and wherein the controller is configured to control the first and second switches to control the positive input current and the negative input current at the one input when coupled to the one input, wherein the frequency-dependent resistor and inductor and the component are configured to operate as a series resonant circuit with the voltage source through operation of the first switch, and wherein the component and the inductor are configured to operate as a series resonant circuit through operation of the second switch.

9. The device of claim 8, wherein the controller is configured to control the first switch to discontinue charging of the component after the component is charged to a potential of the battery and/or supercapacitor and is thereafter configured to control the second switch to start discharging of the component.

10. The device of claim 8, wherein the controller is configured to close the second switch to control the discharge of the component and is configured to open the second switch after the charge from the component has been transferred to the inductor and the charge from the inductor has been transferred back to the component by a resonant transfer.

11. The device of claim 8, wherein the controller is configured to control actuation and de-actuation of the respective first and second switches at a zero crossing between the positive input current and the negative input current wherein no positive input current and negative input current is provided.

12. The device of claim 2, wherein the at least one power storage and source comprises a component configured to be charged by the voltage source through the one input, the device comprising a first switch, a second switch, a third switch, and a fourth switch, and the controller is configured to control the first, second, third and fourth switches to control the positive input current and the negative input current at the one input when coupled to the one input.

13. The device of claim 12, wherein the controller is configured to control the first and third switches and the second and fourth switches in tandem with either of the first and third switches and the second and fourth switches actuated or de-actuated together at a zero crossing between the positive input current and the negative input current wherein no positive input current and negative input current is provided, to control the positive input current and the negative input current at the one input when coupled to the one input.

14. The device of claim 2, wherein the at least one power storage and source couplable to the one input is a first at least one power storage and source, the device comprising a second at least one power storage and source couplable to the one input, wherein the controller is configured to control the first at least one power storage and source couplable to the one input to provide the positive input current and a negative input current at the one input when coupled to the one input when the battery and/or supercapacitor is/are below the operational temperature range of the battery and/or supercapacitor and the controller is configured to control the second at least one power storage and source couplable to the one input to provide the positive input current and a negative input current at the one input when coupled to the one input when the battery and/or supercapacitor is/are within the operational temperature range of the battery and/or supercapacitor.

15. The device of claim 2, wherein, when heating is enabled, the controller is configured to start the at least one power storage and source to provide the alternating positive and negative input currents at the one input in response to a predetermined temperature that is lower than an operational temperature range of the battery and/or supercapacitor.

16. A device for direct battery electrolyte and supercapacitor heating and temperature maintenance at low temperatures when coupled to a battery and/or supercapacitor having a core with an electrolyte having ions therein, the battery and/or supercapacitor having inputs, with one of the inputs having characteristics of a frequency-dependent resistor and inductor series coupled to a voltage source, the device comprising:
at least one power source couplable to the one input, wherein the at least one power storage and source is configured to provide a positive input current and a negative input current at the one input when coupled to the one input; and
a controller configured to control the at least one power source to provide alternating between the positive input current and the negative input current at the one input at a high-frequency configured to substantially maximize an internal heating effect of the ions within the electrolyte of the battery and/or supercapacitor to generate heat and raise a temperature of the electrolyte; and
a switch, wherein the at least one power storage and source comprises a component configured to be charged by the voltage source through the frequency-dependent resistor and inductor of the battery and/or supercapacitor, and the switch,
wherein the controller is configured to control the switch to provide the alternating between the positive input current and the negative input current at the one input and to discontinue the alternating positive and negative input currents based on whether the temperature of the electrolyte, the battery and/or supercapacitor is within an operational temperature range of the battery and/or supercapacitor.
